(19) United States
(12) Patent Application Publication
(10) Pub. No.: US 2023/0141894 A1
(43) Pub. Date: May 11, 2023

(54) DELIVERY MANAGEMENT DEVICE AND DELIVERY MANAGEMENT METHOD

(71) Applicant: TOYOTA JIDOSHA KABUSHIKI KAISHA, Toyota-shi (JP)

(72) Inventors: Ryo MURAKAMI, Susono-shi (JP); Shinnosuke SHIMOKAWA, Susono-shi (JP); Junichi MORI, Nagakute-shi (JP); Sokfan YEE, Toyota-shi (JP); Kensaku SHIBATA, Toyota-shi (JP); Yuta MANIWA, Susono-shi (JP)

(21) Appl. No.: 17/929,046

(22) Filed: Sep. 1, 2022

(30) Foreign Application Priority Data
Nov. 11, 2021 (JP) 2021-184306

(51) Int. Cl. G06Q 10/08; G06Q 50/30; G06Q 30/02; G06F 21/31

(52) U.S. Cl. CPC G06Q 10/0834; G06Q 10/08355; G06Q 10/0833; G06Q 50/30; G06Q 30/0207; G06F 21/31

(57) ABSTRACT

A control unit of a server includes: a delivery request receiving unit configured to receive a delivery request for a parcel from a terminal of a delivery requester that requests a delivery of the parcel; a movable body selection unit configured to select a movable body that delivers the parcel, based on an address of a receiver of the parcel and operation information about a plurality of movable bodies that is periodically operated for each route, the address of the receiver being included in the delivery request; and a carry-in instruction sending unit configured to send a carry-in instruction to the terminal, the carry-in instruction being an instruction to carry the parcel in the selected movable body.

### CROSS-REFERENCE TO RELATED APPLICATION

This application claims priority to Japanese Patent Application No. 2021-184306 filed on Nov. 11, 2021, incorporated herein by reference in its entirety.

### BACKGROUND

### 1. Technical Field

The disclosure relates to a delivery management device and a delivery management method.

### 2. Description of Related Art

Conventionally, it is known that the integration of a parcel distribution service and a human transportation service such as a taxi reduces unnecessary personnel costs and facility costs and allows an efficient service operation (for example, Japanese Unexamined Patent Application Publication No 2004-059213 (JP 2004-059213 A)).

### SUMMARY

However, in the technology described in JP 2004-059213 A, small packages and DMs are delivered using vehicles and manpower of a taxi company or newspaper shop in a region, and parcels are allocated to distribution staff members, based on a working situation (vacant time) of transportation vehicles or manpower. Therefore, there is a problem in that it is difficult to deliver parcels in the case where it is not possible to sufficiently secure the vacant time of transportation vehicles or manpower.

In view of the above problem, and an object of the present disclosure is to provide a delivery management device and a delivery management method that make it possible to deliver parcels using a plurality of movable bodies that is periodically operated for each route.

The summary of the present disclosure is shown as follows.

(1) A delivery management device including:

a delivery request receiving unit configured to receive a delivery request for a parcel from a first terminal, the first terminal being a terminal of a delivery requester that requests a delivery of the parcel;

a movable body selection unit configured to select a movable body that delivers the parcel, based on an address of a receiver of the parcel and operation information about a plurality of movable bodies that is periodically operated for each route, the address of the receiver being included in the delivery request; and

a carry-in instruction sending unit configured to send a carry-in instruction to the first terminal, the carry-in instruction being an instruction to carry the parcel in the selected movable body.

(2) The delivery management device according to the above (1), in which when the delivery request includes a designated delivery time, the movable body selection unit selects the movable body that delivers the parcel, based on the designated delivery time, the address of the receiver, and the operation information.

(3) The delivery management device according to the above (1), further including:

a delivery intention receiving unit configured to receive a delivery intention from a second terminal, the delivery intention indicating an intention to deliver the parcel; and

a delivery instruction sending unit configured to send a delivery instruction to the second terminal, the delivery instruction being an instruction to unload the parcel at a stop place for the movable body and to deliver the parcel to the address of the receiver.

(4) The delivery management device according to the above (3), in which the delivery instruction includes the address of the receiver, operation information about the movable body in which the parcel is carried, and information designating the stop place where the parcel is unloaded.

(5) The delivery management device according to the above (3) or (4), including a sending unit configured to send a request to deliver the parcel from the stop place to the address of the receiver, to a plurality of the second terminals, in which

the delivery instruction sending unit sends the delivery instruction to the second terminal that has returned an agreement to the request earliest among the second terminals.

(6) The delivery management device according to the above (3) or (4), including a getting-off schedule receiving unit configured to receive a getting-off schedule for the movable body, the getting-off schedule being sent by the second terminal, in which:

the getting-off schedule includes a scheduled stop place for getting off the movable body; and

the delivery instruction sending unit sends the delivery instruction to the second terminal based on the address of the receiver and the getting-off schedule, the delivery instruction being an instruction to unload the parcel at the scheduled stop place for getting off the movable body, and to deliver the parcel to the address of the receiver.

(7) The delivery management device according to the above (6), including a sending unit configured to send a request to deliver the parcel from the scheduled stop place for getting off the movable body to the address of the receiver, to a plurality of the second terminals, in which

the delivery instruction sending unit sends the delivery instruction to the second terminal for which the scheduled stop place for getting off the movable body is closest to the address of the receiver among the second terminals that have returned an agreement to the request.

(8) The delivery management device according to the above (7), in which:

the getting-off schedule includes a scheduled time for getting off the movable body; and

when the delivery request includes a designated delivery time, the sending unit sends the request to the second terminal that has sent the getting-off schedule in which the scheduled time is close to the designated delivery time.

(9) The delivery management device according to any one of the above (6) to (8), in which based on the getting-off schedule for the second terminal to which the delivery instruction has been sent, the movable body selection unit selects the movable body for which getting-off is scheduled to be performed, as the movable body in which the parcel is carried.

(10) The delivery management device according to any one of the above (3) to (9), in which depending on degree of lack of exercise of an owner of the second terminal, the delivery instruction sending unit changes the stop place where the parcel is unloaded, to a stop place that is more distant from the address of the receiver, as the degree of the lack of exercise is higher, the degree of the lack of exercise being received from the second terminal.

(11) The delivery management device according to any one of the above (3) to (10), in which:

the delivery instruction sending unit sends first identification information for authentication to the second terminal, the first identification information being used when the parcel is unloaded from the movable body at the stop place; and

the delivery management device includes an identification information sending unit configured to send collation identification information to an authentication device, the collation identification information being collated with the first identification information, the authentication device being included in the selected movable body and authenticating the first identification information.

(12) The delivery management device according to any one of the above (3) to (11), further including a compensation sending unit configured to send a compensation for the delivery to the second terminal to which the delivery instruction has been sent, in response to a delivery completion report for the parcel from the second terminal.

(13) The delivery management device according to the above (1), including a receipt instruction sending unit configured to send a receipt instruction to a third terminal, the receipt instruction being an instruction to receive the parcel at a stop place for the movable body where the parcel is unloaded, the third terminal being a terminal of the receiver.

(14) The delivery management device according to the above (13), including a receipt request sending unit configured to send a receipt request to the third terminal, the receipt request being a request to receive the parcel at the stop place where the parcel is unloaded, in which

the receipt instruction sending unit sends the receipt instruction to the third terminal that has returned an agreement to the receipt request.

(15) The delivery management device according to the above (13) or (14), in which the receipt instruction includes operation information about the movable body in which the parcel is carried and information designating the stop place where the parcel is unloaded.

(16) The delivery management device according to any one of the above (13) to (14), in which

the parcel unloaded from the movable body is stored in a storage box that is provided at the stop place for the movable body;

the receipt instruction sending unit sends second identification information for authentication to the third terminal, the second identification information being used for unlocking a door of the storage box; and

the delivery management device includes an identification information sending unit configured to send collation identification information to an authentication device, the collation identification information being collated with the second identification information, the authentication device being included in the storage box and authenticating the second identification information.

(17) The delivery management device according to the above (15), in which the receipt instruction further includes a scheduled time when the movable body stops at the stop place where the parcel is unloaded.

(18) The delivery management device according to any one of the above (13) to (17), in which depending on degree of lack of exercise of the receiver, the receipt instruction sending unit changes the stop place where the parcel is unloaded, to a stop place that is more distant from the address of the receiver, as the degree of the lack of exercise is higher, the degree of the lack of exercise being received from the third terminal.

(19) The delivery management device according to any one of the above (13) to (18), further including a compensation sending unit configured to send a compensation for the receipt of the parcel to the third terminal to which the receipt instruction has been sent, in response to a receipt completion report for the parcel from the third terminal.

(20) The delivery management device according to the above (12) or (19), in which the compensation sending unit sends a higher compensation as the distance between the stop place where the parcel is unloaded and the address of the receiver is longer.

(21) The delivery management device according to any one to the above (3) to (20), the stop place where the parcel is unloaded is a stop place nearest to the address of the receiver.

(22) The delivery management device according to any one to the above (1) to (21), in which:

the carry-in instruction sending unit sends third identification information for authentication to the first terminal, the third identification information being used when the parcel is carried in the movable body; and

the delivery management device includes an identification information sending unit configured to send collation identification information to an authentication device, the collation identification information being collated with the third identification information, the authentication device being included in the selected movable body and authenticating the third identification information.

(23) A delivery management method including:

a step of receiving a delivery request for a parcel from a terminal of a delivery requester that requests a delivery of the parcel;

a step of selecting a movable body that delivers the parcel, based on an address of a receiver of the parcel and operation information about a plurality of movable bodies that is periodically operated for each route, the address of the receiver being included in the delivery request; and

a step of sending a carry-in instruction to the terminal, the carry-in instruction being an instruction to carry the parcel in the selected movable body.

The present disclosure provides a delivery management device and a delivery management method that make it possible to deliver parcels using a plurality of movable bodies that is periodically operated for each route.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing the configuration of a parcel delivery system according to a first embodiment of the disclosure;

FIG. 2 is a block diagram showing hardware configurations of terminals, a server, and a movable body;

FIG. 3 is a schematic diagram showing a functional block of a control unit that is included in each of a terminal of a delivery requester, a terminal of a receiver, and a terminal of a deliverer;

FIG. 4 is a schematic diagram showing a functional block of a control unit that is included in the server;

FIG. 5 is a sequence diagram showing processes that are performed by the terminal of the requester, the terminal of the deliverer, and the server;

FIG. 6 is a sequence diagram showing processes that are performed by the terminal of the requester, the terminal of the deliverer, and the server, and is a diagram in the case of deciding the deliverer based on a getting-on/off schedule for the movable body;

FIG. 7 is a schematic diagram showing the configuration of a parcel delivery system according to a second embodiment of the disclosure;

FIG. 8 is a block diagram showing hardware configurations of terminals, a server, a movable body, and a storage box;

FIG. 9 is a schematic diagram showing a functional block of a control unit that is included in the server in the second embodiment; and

FIG. 10 is a sequence diagram showing processes that are performed by the terminal of the requester, the terminal of the receiver, and the server.

### DETAILED DESCRIPTION OF EMBODIMENTS

Some embodiments according to the disclosure will be described below with reference to the drawings. The descriptions are intended to merely show exemplary preferred embodiments of the disclosure, and are not intended to limit the disclosure to particular embodiments. In the following descriptions, the same constituent elements are denoted by identical reference numerals.

### 1. First Embodiment

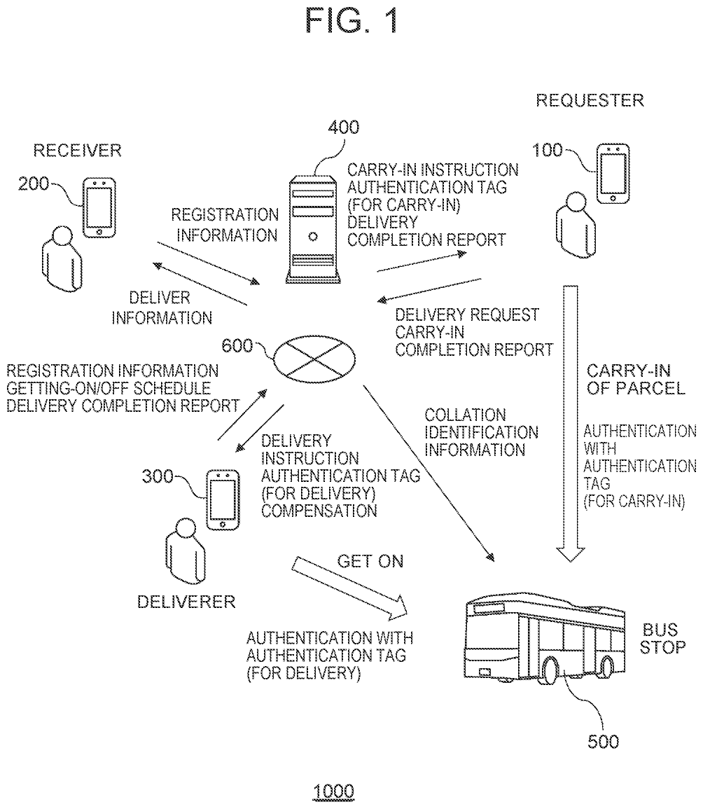

FIG. 1 is a schematic diagram showing the configuration of a parcel delivery system 1000 according to a first embodiment of the disclosure. The parcel delivery system 1000 is configured to include a terminal 100 of a delivery requester that requests the delivery of a parcel, a terminal 200 of a receiver of the parcel, a terminal 300 of a deliverer of the parcel, a server 400, and a plurality of movable bodies 500 that travels on roads and on which parcels are loaded. The terminals 100, 200, 300, the server 400, and the movable bodies 500 are connected through a communication network 600 such as the Internet, in a communicable manner. The terminals 100, 200, 300, the server 400, and the movable bodies 500 may be connected through a wireless communication such as WiFi, a wireless network including a mobile telephone network such as LTE, LTE-Advance, 4G, and 5G, a dedicated network such as virtual private network (VPN), or a network such as LAN.

The movable body 500, which is a vehicle such as an automobile, is periodically operated for each route, and travels on a road. In the embodiment, the movable body 500 is a transit bus, for example. As an example, the movable body 500 may be an automatic driving bus that travels on the road based on a preset command and that transports passengers, and may be periodically operated in a smart city. The smart city, which has been recommended by Ministry of Land, Infrastructure and Transport, is a sustainable city or district where the optimization is achieved as a whole by performing management (planning, preparation, control/operation, and the like) while utilizing new technologies such as Information and Communication Technology (ICT) for problems in the city. The movable body 500 is not limited to a vehicle that is automatically driven, and may be a vehicle that is manually driven. The parcel delivery system 1000 provides a service in which the parcel is delivered using the movable body 500.

The terminal 100 is a terminal of a delivery requester (for example, a distribution company that distributes the parcel, an individual person that hopes to send the parcel, or the like) that requests the delivery of the parcel, and sends a delivery request for the parcel to the server 400. In the case where the delivery requester is an individual person or the like, the sender is often the delivery requester. On the other hand, in the case where the delivery requester is a distribution company, the sender is an individual person or the like that sends the parcel through the distribution company that is the delivery requester.

When the server 400 receives the delivery request, the server 400 sends, to the terminal 100, a carry-in instruction for instructing the delivery requester to carry the parcel in the movable body 500. Further, the server 400 sends an electronic authentication tag (identification information) for carry-in to the terminal 100. For example, the authentication tag for carry-in is a bar code, a QR code (R), or the like. The delivery requester carries the parcel in the movable body 500, based on the carry-in instruction. Furthermore, the server 400 sends collation identification information that is collated with the authentication tag, to the movable body 500.

The terminal 200 is a terminal of the receiver of the parcel. The receiver previously performs user registration by sending user registration information for enjoying the service by the parcel delivery system 1000, to the server 400, using the terminal 200. In the first embodiment, the user registration is not essential, and the parcel delivery system 1000 may deliver the parcel to a receiver that has not performed the user registration. The server 400 sends information (information about whether shipment is completed, information about whether delivery delay occurs, or the like) relevant to the delivery status of the parcel, to the terminal 200 of the receiver.

The terminal 300 is a terminal of the deliverer that delivers the parcel carried in the movable body 500, to the receiver. The deliverer previously performs user registration by sending user registration information for enjoying the service by the parcel delivery system 1000, to the server 400, using the terminal 300.

Further, the deliverer sends a getting-on/off schedule for the movable body 500, to the server 400, using the terminal 300. As for the getting-on/off schedule, in the case where the deliverer periodically uses the movable body 500 for going to the office, school, or the like, the deliverer may send scheduled times when the deliverer periodically gets on and off the movable body 500, stop places (bus stops) where the deliverer periodically gets on and off the movable body 500, a route for the movable body 500 that the deliverer periodically gets on and off, and the like, to the server 400, as the getting-on/off schedule. On the other hand, in the case where the deliverer uses the movable body 500 at an arbitrary timing (irregularly), the deliverer may send scheduled times when the deliverer gets on and off the movable body 500, stop places where the deliverer gets on and off the movable body 500, a route for the movable body 500 that the deliverer gets on and off, and the like, to the server 400, as the getting-on/off schedule.

The server 400 decides the deliverer that delivers the parcel, and sends the delivery instruction for the parcel and an electronic authentication tag for delivery, to the terminal 300 of the deliverer. Similarly to the authentication tag for carry-in, for example, the authentication tag for delivery is a bar code, a QR code (R), or the like. Furthermore, the server 400 sends collation identification information to be collated with the authentication tag for delivery, to the movable body 500. The deliverer refers to, from the delivery instruction, operation information about the movable body 500 and information designating a stop place where the parcel is unloaded, and unloads the parcel from the movable body 500, at a stop place close to the address of the receiver. The deliverer may get on the movable body 500 at a stop place before the stop place where the parcel is unloaded, and may unload the parcel from the movable body 500 when the movable body 500 stops at the stop place where the parcel is unloaded, based on the operation information about the movable body 500 in which the parcel is carried. Further, the delivery may go to the stop place where the parcel is unloaded, without getting on the movable body 500 in which the parcel is carried, and may unload the parcel from the movable body 500, based on the information designating the stop place where the parcel is unloaded. Then, the deliverer refers to the address of the receiver that is included in the deliver instruction, and delivers the parcel to the address of the receiver. When the delivery of the parcel by the deliverer is completed, the server 400 sends a compensation to the terminal 300 of the deliverer. The compensation may be an electronic money or may be an electronic point that can be used in a point service.

As described above, in the parcel delivery system 1000 according to the embodiment, the requester that requests the delivery of the parcel carries the parcel in the movable body 500 in accordance with the instruction from the server 400. The parcel is transported by the movable body 500. The deliverer unloads the parcel from the movable body 500 and delivers the parcel to the address of the receiver, in accordance with the instruction from the server 400. Accordingly, it is possible to deliver the parcel using the movable body 500 that is usually operated. Further, the deliverer does not need to be a professional business operator, and therefore a dedicated vehicle and dedicated deliverer for delivering the parcel are unnecessary. Since an ordinary person participates in the physical distribution service, manpower shortage in the physical distribution service is eliminated, and delivery costs are reduced. Further, the deliverer can perform the delivery and obtain the compensation, while using vacant time. Furthermore, by delivering the parcel from the stop place close to the address of the receiver to the address of the receiver, the deliverer can eliminate the lack of exercise and can achieve health promotion. Further, in the case where the deliverer is a receiver's neighbor, the receiver can have a sense of unity for the community and a sense of safety.

In the embodiment, two aspects: a first aspect and a second aspect are shown as examples. In the first aspect, the deliverer is decided from terminals 200 that have sent the user registration information to the server 400 in advance. In the second aspect, the deliverer is decided based on the getting-on/off (getting-off) schedule for the movable body 500. In the following, first, the first aspect will be described, and subsequently, the second aspect will be described.

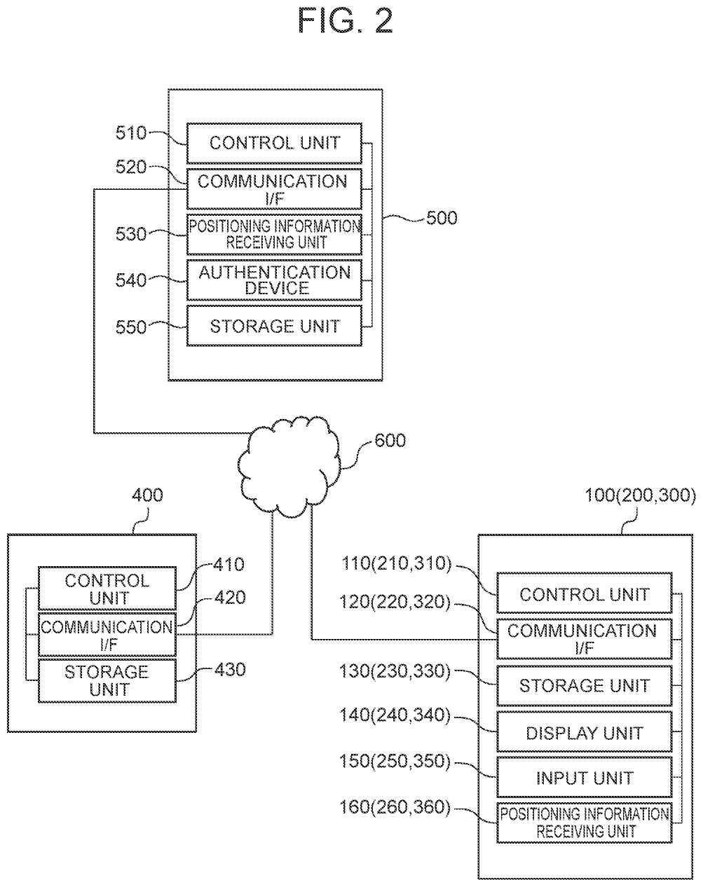

FIG. 2 is a block diagram showing hardware configurations of the terminals 100, 200, 300, the server 400, and the movable body 500. Here, an example in which each of the terminals 100, 200, 300 is constituted by a smartphone is shown. However, each of the terminals 100, 200, 300 may be constituted by an electronic device such as a personal computer (PC) and a tablet terminal. The hardware configurations of the terminals 100, 200, 300 are the same as each other. Therefore, the configuration of the terminal 100 of the terminals 100, 200, 300 will be described here.

The terminal 100 includes a control unit 110, a communication I/F 120, a storage unit 130, a display unit 140, an input unit 150, and a positioning information receiving unit 160.

The control unit 110 of the terminal 100 is constituted by a processor. The processor includes a single or a plurality of central processing units (CPUs) and peripheral circuits. The processor may further include another arithmetic circuit such as an arithmetic-logic unit, a numerical arithmetic unit, or a graphics processor unit. The control unit 110 provides a function matching a predetermined purpose, by executing a computer program expanded at a working area of the storage unit 130 in an executable manner.

The communication I/F 120 of the terminal 100 is a communication interface for the communication network 600, and, for example, includes an antenna and a signal processing circuit that executes various processes related to wireless communication, as exemplified by the modulation and demodulation of wireless signals. For example, the communication I/F 120 receives a downlink wireless signal from a wireless base station connected with the communication network 600, and sends an uplink wireless signal to a wireless base station. The communication I/F 120 takes out a signal transmitted from the server 400 to the terminal 100, from the received downlink wireless signal, and transfers the taken signal to the control unit 110. Further, the communication I/F 120 generates an uplink wireless signal including a signal that is received from the control unit 110 and that is sent to the server 400, and sends the wireless signal.

The storage unit 130 of the terminal 100 includes a volatile semiconductor memory and a non-volatile semiconductor memory. The display unit 140 of the terminal 100 is configured by a liquid crystal display (LCD), for example, and displays a variety of information. The input unit 150 of the terminal 100 is constituted by a touch sensor or a keyboard, for example, and information corresponding to user's operation is input to the terminal 100. In the case where the input unit 150 is constituted by a touch sensor, the display unit 140 and the input unit 150 integrally constitute a touch panel.

The positioning information receiving unit 160 of the terminal 100 acquires positioning information indicating the current position and attitude of the terminal 100. For example, a global positioning system (GPS) receiver can be adopted as the positioning information receiving unit 160. Whenever the positioning information receiving unit 160 receives the positioning information, the positioning information receiving unit 160 outputs the acquired positioning information to the control unit 110 through a network in the terminal 100.

Similarly, the terminal 200 includes a control unit 210, a communication I/F 220, a storage unit 230, a display unit 240, an input unit 250, and a positioning information receiving unit 260, and the terminal 300 includes a control unit 310, a communication I/F 320, a storage unit 330, a display unit 340, an input unit 350, and a positioning information receiving unit 360. The control units 210, 310, the communication I/F 220, 320, the storage units 230, 330, the display units 240, 340, the input units 250, 350, and the positioning information receiving units 260, 360 are configured similarly to the control unit 110, the communication I/F 120, the storage unit 130, the display unit 140, the input unit 150, and the positioning information receiving unit 160 of the terminal 100, respectively.

The server 400 includes a control unit 410, which is an aspect of the delivery management device, a communication I/F 420, and a storage unit 430. The control unit 410 of the server 400 is constituted by a processor, similarly to the control unit 110 of the terminal 100. The communication I/F 420 of the server 400 includes a communication module that is connected with the communication network 600. For example, the communication I/F 420 may include a communication module that complies with a wired local area network (LAN) standard. The server 400 is connected with the communication network 600 through the communication I/F 420. For example, the storage unit 430 of the server 400 includes a volatile semiconductor memory and a non-volatile semiconductor memory, similarly to the storage unit 130 of the terminal 100. In the storage unit 430, operation information about each movable body 500 is stored. The operation information includes an operation route for the movable body 500, stop places, scheduled times when the movable body 500 stops at the stop places, and others.

The movable body 500 includes a control unit 510, a communication I/F 520, a positioning information receiving unit 530, an authentication device 540, and a storage unit 550. The control unit 510, the communication I/F 520, the positioning information receiving unit 530, and the storage unit 550 of the movable body 500 are configured similarly to the control unit 110, the communication I/F 120, the positioning information receiving unit 160, and the storage unit 130 of the terminal 100, respectively. The authentication device 540 includes a reader (for example, a bar code reader or a QR (R) code reader) that reads an authentication tag for carry-in, delivery, or receipt, and collates the authentication tag sent to the terminal 100 or the terminal 300, with the collation identification information transmitted from the server 400 to the movable body 500. The authentication device 540 is an aspect of an authentication device that is included in the movable body 500 and that authenticates the authentication tag (identification information). The authentication device that is included in the movable body 500 and that authenticates the authentication tag may be a portable terminal that has a wireless communication function and that is held by a crew of the movable body 500.

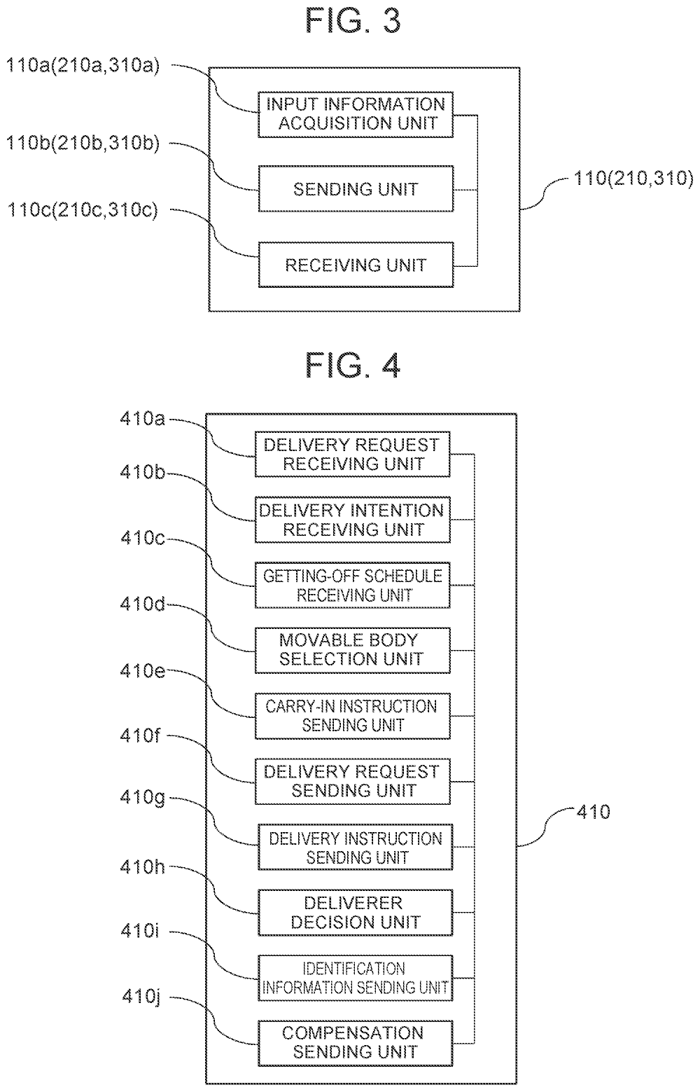

FIG. 3 is a schematic diagram showing a functional block of the control unit 110, 210, 310 that is included in each of the terminal 100 of the delivery requester, the terminal 200 of the receiver, and the terminal 300 of the deliverer. The control unit 110 of the terminal 100 includes an input information acquisition unit 110a, a sending unit 110b, and a receiving unit 110c. For example, each of the units included in the control unit 110 is a functional module to be realized by a computer program that acts on the control unit 110. That is, each of the units included in the control unit 110 is constituted by the control unit 110 and a program (software) for causing the control unit 110 to function. Further, the program may be recorded in the storage unit 130 of the terminal 100 or a recording medium connected with the exterior. Alternatively, each of the units included in the control unit 110 may be a dedicated arithmetic circuit that is provided in the control unit 110.

The input information acquisition unit 110a of the control unit 110 of the terminal 100 of the delivery requester acquires a delivery request that the requester has input by operating the input unit 150. The delivery request includes information (the address, name, telephone number, e-mail address, and others of the receiver, the address, name, telephone number, e-mail address, and others of the sender, a designated delivery date and a designated delivery time (if designated), the content of the parcel, and the like) relevant to the delivery of the parcel. The sending unit 110b of the control unit 110 performs a process of sending the delivery request, a carry-in completion report, position information about the terminal 100, and the like to the server 400 through the communication I/F 120. The receiving unit 110c of the control unit 110 performs a process of receiving the carry-in instruction that is an instruction to carry the parcel in the movable body 500 and that is sent from the server 400, through the communication I/F 120. Further, the receiving unit 110c performs a process of receiving a delivery completion report sent from the server 400, through the communication I/F 120.

Similarly, the control unit 210 of the terminal 200 of the receiver includes an input information acquisition unit 210a, a sending unit 210b, and a receiving unit 210c. The input information acquisition unit 210a of the control unit 210 acquires user registration information that the receiver has input by operating the input unit 250. The user registration information includes the ID, password, address, name, telephone number, e-mail address, and others of the receiver. The sending unit 210b of the control unit 210 performs a process of sending the user registration information, position information about the terminal 200, and the like to the server 400 through the communication I/F 220. The receiving unit 210c of the control unit 210 performs a process of receiving information that is relevant to the delivery status of the parcel and that is sent from the server 400, through the communication I/F 220.

Similarly, the control unit 310 of the terminal 300 of the deliverer includes an input information acquisition unit 310a, a sending unit 310b, and a receiving unit 310c. The input information acquisition unit 310a of the control unit 310 acquires user registration information that the owner of the terminal 300 has input by operating the input unit 350. The user registration information includes an ID, a password, an address, a name, a telephone number, an e-mail address, and a delivery intention. For example, the delivery intention includes a content “I will deliver a parcel from a bus stop to a delivery destination if requested”.

Further, the input information acquisition unit 310a acquires an agreement to the delivery request that the deliverer has input by operating the input unit 350. Further, the input information acquisition unit 310a acquires information that indicates the completion of the delivery and that the deliverer has input by operating the input unit 350. Further, the input information acquisition unit 310a acquires information that indicates the degree of the lack of exercise and that the deliverer has input by operating the input unit 350. In the case where the terminal 300 includes a pedometer, the degree of the lack of exercise may be acquired based on the number of steps counted by the pedometer.

The sending unit 310b of the control unit 310 performs a process of sending the user registration information, the agreement to the delivery request, the delivery completion report, the degree of the lack of exercise, and the like to the server 400 through the communication I/F 220. The receiving unit 310c of the control unit 310 performs a process of receiving the delivery request for the parcel, the delivery instruction, the authentication tag, the compensation, and the like, which are sent from the server 400, through the communication I/F 320.

FIG. 4 is a schematic diagram showing a functional block of the control unit 410 that is included in the server 400. The control unit 410 of the server 400 includes a delivery request receiving unit 410a, a delivery intention receiving unit 410b, a getting-off schedule receiving unit 410c, a movable body selection unit 410d, a carry-in instruction sending unit 410e, a delivery request sending unit 410f, a delivery instruction sending unit 410g, a deliverer decision unit 410h, an identification information sending unit 410i, and a compensation sending unit 410j. For example, each of the units included in the control unit 410 is a functional module to be realized by a computer program that acts on the control unit 410. That is, each of the units included in the control unit 410 is constituted by the control unit 410 and a program (software) for causing the control unit 410 to function. Further, the program may be recorded in the storage unit 430 of the server 400 or a recording medium connected with the exterior. Alternatively, each of the units included in the control unit 410 may be a dedicated arithmetic circuit that is provided in the control unit 410.

The delivery request receiving unit 410a of the control unit 410 receives the delivery request for the parcel, from the terminal 100 of the requester that requests the delivery of the parcel. The delivery intention receiving unit 410b of the control unit 410 receives the delivery intention indicating the intention of the delivery of the parcel, from the terminal 300 of the deliverer.

The movable body selection unit 410d of the control unit 410 selects the movable body 500 that delivers the parcel, based on the address of the receiver of the parcel that is included in the delivery request and the operation information about the movable bodies 500 that are periodically operated for each route. More specifically, the movable body selection unit 410d refers to the operation information about each movable body 500 that is previously stored in the storage unit 430, and selects the movable body 500 in which the parcel is carried, based on the current position of the terminal 100 of the delivery requester when the delivery request is sent, and the address of the receiver. For example, a movable body 500 having an operation route including both a stop place nearest to the current position of the terminal 100 of the delivery requester and a stop place nearest to the address of the receiver is selected as the movable body 500 that delivers the parcel. Further, in the case where the delivery request includes the designated delivery time, the movable body selection unit 410d selects the movable body 500 that delivers the parcel, based on the designated delivery time, the address of the receiver, and the operation information about the movable body 500. For example, in consideration of a required time period for delivering the parcel from the stop place close to the address of the receiver to the address of the receiver, a movable body 500 that will arrive at the stop place nearest to the address of the receiver by the time that is earlier than the designated delivery time by the required time period is selected as the movable body 500 in which the parcel is carried. The movable body selection unit 410d may select a movable body 500 having an operation route including a stop place previously registered by the receiver or the delivery requester, as the movable body that delivers the parcel.

The carry-in instruction sending unit 410e of the control unit 410 sends the carry-in instruction that is an instruction to carry the parcel in the selected movable body 500, to the terminal 100. The carry-in instruction includes the operation information about the selected movable body 500, information indicating a stop place nearest to the terminal 100, a scheduled time when the selected movable body 500 stops at the stop place nearest to the terminal 100, and the like. The carry-in instruction sending unit 410e sends the authentication tag for carry-in that is used when the parcel is carried in the movable body 500, to the terminal 100 of the requester, together with the carry-in instruction.

the delivery request sending unit 410f of the control unit 410 sends a request (delivery request) to deliver the parcel from the stop place to the address of the receiver, to a plurality of terminals 300. The delivery request includes the address of the receiver, the information designating the stop place where the parcel is unloaded, the operation information about the selected movable body 500, a scheduled time when the selected movable body 500 stops at the stop place where the parcel is unloaded, and the like. The stop place where the parcel is unloaded may be a stop place close to the address of the receiver, more specifically, a stop place nearest to the address of the receiver.

The delivery instruction sending unit 410g of the control unit 410 sends, to the terminal 300, the delivery instruction that is an instruction to unload the parcel at the stop place of the movable body 500 and to deliver the parcel to the address of the receiver. The delivery instruction includes the address of the receiver, the operation information about the movable body 500 in which the parcel is carried, and the information designating the stop place where the parcel is unloaded. More specifically, the delivery instruction includes the address, name, telephone number, and others of the receiver, the operation information about the movable body 500 in which the parcel is carried, the information designating the stop place where the parcel is unloaded, and the instruction to unload the parcel at the stop place where the parcel is unloaded and to deliver the parcel to the address of the receiver. The delivery instruction sending unit 410g may send the delivery instruction to a terminal 300 that has returned the agreement to the delivery request earliest among the terminals 300 to which the delivery request has been sent. Further, the delivery instruction sending unit 410g may send the delivery instruction to a terminal 300 that is at a position closest to the stop place nearest to the address of the receiver among terminals 300 that have returned the agreement to the delivery request. Depending on the degree of the lack of exercise of the owner of the terminal 300 that is received from the terminal 300, the delivery instruction sending unit 410g may change the stop place where the parcel is unloaded, to a stop place that is more distant from the address of the receiver, as the degree of the lack of exercise is higher. The delivery instruction sending unit 410g sends the authentication tag that is used when the parcel is unloaded from the movable body 500 at the stop place where the parcel is unloaded, to the terminal 300 of the deliverer, together with the delivery instruction.

The deliverer decision unit 410h of the control unit 410 decides the deliverer that delivers the parcel. From the terminals 300, the deliverer decision unit 410h decides a terminal to which the delivery instruction sending unit 410g sends the delivery instruction.

The identification information sending unit 410i of the control unit 410 sends the collation identification information to be collated with the authentication tag for carry-in that is sent to the terminal 100 by the carry-in instruction sending unit 410e, to the authentication device 540 that is included in the movable body 500 selected by the movable body selection unit 410d and that authenticates the authentication tag for carry-in. Further, the identification information sending unit 410i sends the collation identification information to be collated with the authentication tag for delivery that is sent to the terminal 300 by the delivery instruction sending unit 410g, to the authentication device 540 that is included in the movable body 500 selected by the movable body selection unit 410d and that authenticates the authentication tag for carry-in.

The compensation sending unit 410j sends the compensation for the delivery to the terminal 300 to which the delivery instruction has been sent, in response to the delivery completion report for the parcel from the terminal 300. The compensation sending unit 410j sends a higher compensation as the distance between the stop place where the parcel is unloaded and the address of the receiver is longer.

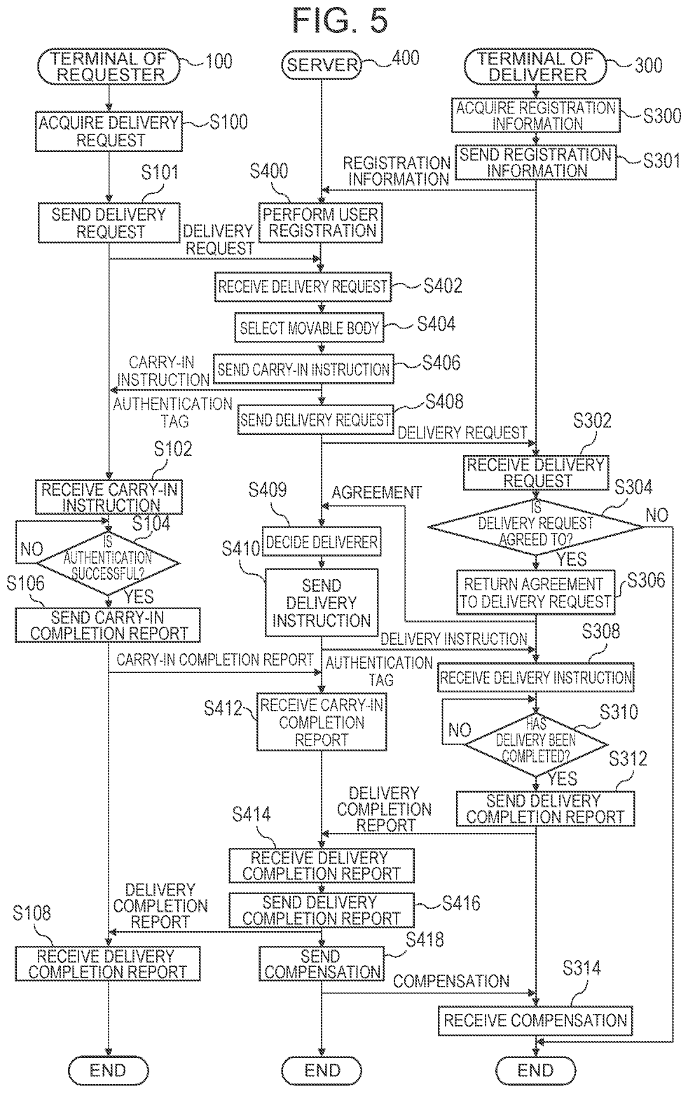

FIG. 5 is a sequence diagram showing processes that are performed by the terminal 100 of the requester, the terminal 300 of the deliverer, and the server 400. The processes shown in FIG. 5 are performed by the control unit 110 of the terminal 100 of the requester, the control unit 310 of the terminal 300 of the deliver, and the control unit 410 of the server 400.

First, the input information acquisition unit 310a of the control unit 310 of the terminal 300 of the deliverer acquires the user registration information that the deliverer has input by operating the input unit 350 (step S300). Next, the sending unit 310b of the control unit 310 sends the user registration information to the server 400 (step S301). The user registration information is registered in the storage unit 430 by the control unit 410 of the server 400 (step S400). Thereby, the delivery intention receiving unit 410b of the control unit 410 receives the delivery intention included in the user registration information, from the terminal 300 of the deliverer.

Further, the input information acquisition unit 110a of the control unit 110 of the terminal 100 acquires the delivery request that the requester has input by operating the input unit 150 (step S100). Next, the sending unit 110b of the control unit 110 sends the delivery request to the server 400 (step S101). The delivery request receiving unit 410a of the control unit 410 of the server 400 receives the delivery request (step S402). The sending unit 110b of the control unit 110 of the terminal 100 may send the position information about the terminal 100, together with the delivery request.

Next, the movable body selection unit 410d of the control unit 410 of the server 400 selects the movable body 500 that delivers the parcel, based on the address of the receiver of the parcel that is included in the delivery request, and the operation information about the movable body 500 (step S404). Next, the carry-in instruction sending unit 410e of the control unit 410 of the server 400 sends the carry-in instruction that is an instruction to carry the parcel in the selected movable body 500, to the terminal 100 of the delivery requester (step S406). The carry-in instruction sending unit 410e sends the authentication tag for carry-in, to the terminal 100 of the requester, together with the carry-in instruction. Further, the identification information sending unit 410i of the server 400 sends the collation identification information to be collated with the authentication tag for carry-in, to the movable body 500 selected by the movable body selection unit 410d.

The receiving unit 110c of the control unit 110 of the terminal 100 receives the carry-in instruction sent from the server 400 (step S102). Further, the receiving unit 110c receives the authentication tag for carry-in, together with the carry-in instruction. The carry-in instruction and the authentication tag for carry-in are displayed on the display unit 140 of the terminal 100. The delivery requester sees the carry-in instruction displayed on the display unit 140, and caries the parcel in the movable body 500, in accordance with the carry-in instruction. On this occasion, since the collation identification information to be collated with the authentication tag has been sent to the movable body 500, the delivery requester performs the authentication by causing the authentication device 540 to read the authentication tag in a state where the authentication tag for carry-in is displayed on the display unit 140 of the terminal 100. When the authentication of the authentication tag is successful as a result of the authentication by the authentication device 540 (step S104), information indicating that the authentication of the authentication tag is successful is sent to the terminal 100 and is displayed on the display unit 140, and the parcel is permitted to be carried in the movable body 500. Then, the sending unit 110b of the control unit 110 of the terminal 100 sends the carry-in completion report to the server 400 (step S106). Thereby, the parcel is avoided from being carried in the movable body 500 by a third person that has no authentication tag for carry-in, so that credibility is secured.

In the server 400, after step S406, the delivery request sending unit 410f of the control unit 410 of the server 400 sends the delivery request to the terminals 300 for which the user registration has been performed (step S408).

The receiving unit 310c of the control unit 310 of the terminal 300 receives the delivery request (step S302). The delivery request is displayed on the display unit 340 of the terminal 300, and it is determined whether the delivery request is agreed to, based on the input to the input unit 350 (step S304). When it is determined that the delivery request is agreed to, the sending unit 310b returns the agreement to the delivery request, to the server 400 (step S306). For example, when the owner of the terminal 300 operates an “agreement button” displayed on the display unit 340, it is determined that the delivery request is agreed to, and the agreement to the delivery request is returned. The sending unit 310b may send the position information about the terminal 300 that is received by the positioning information receiving unit 360, together with the agreement to the delivery request.

When the server 400 receives the agreement to the delivery request, the deliverer decision unit 410h of the control unit 410 of the server 400 decides a terminal 300 to which the delivery instruction sending unit 410g sends the delivery instruction, from the terminals 300 (step S409). Next, the delivery instruction sending unit 410g sends the delivery instruction to the decided terminal 300 (step S410). As described above, the delivery instruction sending unit 410g may send the delivery instruction to a terminal 300 that has returned the agreement to the delivery request earliest among the terminals 300 to which the delivery request has been sent. Further, based on the position information about the terminal 300, the delivery instruction sending unit 410g may send the delivery instruction to a terminal 300 that is at a position closest to the stop place nearest to the address of the receiver among terminals 300 that have returned the agreement to the delivery request.

The delivery instruction sending unit 410g sends, to the terminal 300, the authentication tag for delivery that is used when the parcel is unloaded from the movable body 500 at the stop place of the movable body 500, together with the delivery instruction. Further, the identification information sending unit 410i of the control unit 410 of the server 400 sends the collation identification information to be collated with the authentication tag for delivery, to the selected movable body 500.

Next, the receiving unit 310c of the control unit 310 of the terminal 300 receives the delivery instruction (step S308). The owner of the terminal 300 having received the delivery instruction unloads the parcel at the designated stop place and delivers the parcel to the address of the receiver, in accordance with the delivery instruction. When the parcel is unloaded from the movable body 500, since the collation identification information to be collated with the authentication tag for delivery has been sent to the movable body 500, the deliverer performs the authentication by causing the authentication device 540 to read the authentication tag in a state where the authentication tag for delivery is displayed on the display unit 340 of the terminal 300. When the authentication of the authentication tag is successful as a result of the authentication by the authentication device 540, the parcel is permitted to be unloaded. When the authentication is performed, the crew of the movable body 500 reads the authentication tag using the authentication device 540. Thereby, the parcel is avoided from being unloaded from the movable body 500 by a third person that has no authentication tag for delivery, so that credibility is secured.

Next, it is determined whether the delivery has been completed (step S310). When it is determined that the delivery has been completed, the sending unit 310b of the control unit 310 sends the delivery completion report to the server 400 (step S312). For example, when the owner of the terminal 300 operates a “delivery completion button” displayed on the display unit 340 after bringing the parcel to the address of the receiver, it is determined that the delivery has been completed, and the delivery completion report is sent.

When the server 400 receives the carry-in completion report sent by the terminal 100 (step S412) and receives the delivery completion report sent by the terminal 300 (step S414), the control unit 410 of the server 400 sends the delivery completion report to the terminal 100 of the requester (step S416). The receiving unit 110c of the control unit 110 of the terminal 100 receives the delivery completion report (step S108). The delivery completion report is displayed on the display unit 140 of the terminal 100. Thereby, the delivery requester can recognize that the delivery has been completed.

The compensation sending unit 410j of the control unit 410 of the server 400 sends the compensation to the terminal 300 of the deliverer that has completed the delivery (step S418). The receiving unit 310c of the control unit 310 of the terminal 300 receives the compensation (step S314). The received compensation is stored in the storage unit 330 of the terminal 300. When buying products or enjoying various services at shops or the like, the owner of the terminal 300 can make a payment using the compensation stored in the storage unit 330.

Next, the second aspect for deciding the deliverer based on the getting-on/off schedule for the movable body 500 will be described. In this case, the input information acquisition unit 310a of the control unit 310 of the terminal 300 acquires the getting-on/off for the movable body 500 and the delivery intention that the owner of the terminal 300 has input by operating the input unit 350. The getting-on/off schedule includes scheduled times for getting on and off the movable body 500, stop places (bus stops) for getting on and off the movable body 500, the route of the movable body 500 that the owner of the terminal 300 is scheduled to get on and off, and the like. For example, the delivery intention includes a content “I will receive a parcel when getting off a bus and will deliver the parcel from a bus stop to a delivery destination”. The sending unit 310b of the control unit 310 performs a process of sending the getting-on/off schedule and the delivery intention to the server 400 through the communication I/F 220.

The getting-off schedule receiving unit 410c of the control unit 410 of the server 400 receives a getting-off schedule for the movable body 500 that is included in the getting-on/off schedule sent by the terminal 300 of the deliverer. The getting-off schedule includes a scheduled stop place where the owner of the terminal 300 gets off the movable body 500, and a scheduled time when the owner of the terminal 300 gets off the movable body 500. The delivery intention receiving unit 410b of the control unit 410 receives the delivery intention from the terminal 300 of the deliverer.

The delivery request sending unit 410f of the control unit 410 sends a request (deliver request) to deliver the parcel from the scheduled stop place for getting off the movable body 500 to the address of the receiver, to the terminal 300, based on the getting-off schedule. Specifically, the delivery request sending unit 410f sends the delivery request to a terminal 300 having sent a getting-off schedule in which the owner of the terminal 300 gets off the movable body 500 at a stop place close to the address of the receiver. Further, in the case where the delivery request includes a designated delivery time, the delivery request sending unit 410f sends the delivery request to a terminal that has sent a getting-off schedule in which the scheduled getting-off time is close to the designated delivery time. The delivery request includes the address of the receiver and the request to unload the parcel at the time of getting off the movable body 500 and to deliver the parcel to the address of the receiver.

The delivery instruction sending unit 410g of the control unit 410 of the server 400 sends the delivery instruction that is an instruction to unload the parcel at the scheduled stop place for getting off the movable body 500 and to deliver the parcel to the address of the receiver, to the terminal 300, based on the address of the receiver and the getting-off schedule. In the case where the delivery request sending unit 410f sends the delivery request to terminals 300, the delivery instruction sending unit 410g may send the delivery instruction to a terminal 300 that has returned the agreement to the delivery request earliest among the terminals 300. Further, the delivery instruction sending unit 410g may send the delivery instruction to a terminal 300 for which the scheduled stop place for getting off the movable body 500 is closest to the address of the receiver among the terminals 300 that have returned the agreement to the delivery request. The delivery instruction includes the address, name, telephone number, and others of the receiver, the operation information about the movable body 500 in which the parcel is carried, the information designating the stop place where the parcel is unloaded, and the instruction to unload the parcel at the time of getting off the movable body 500 and to deliver the parcel to the address of the receiver.

The movable body selection unit 410d of the control unit 410 selects the movable body 500 for which getting-off is scheduled to be performed, as the movable body in which the parcel is carried, based on the getting-off schedule for the terminal 300 that has sent the delivery instruction.

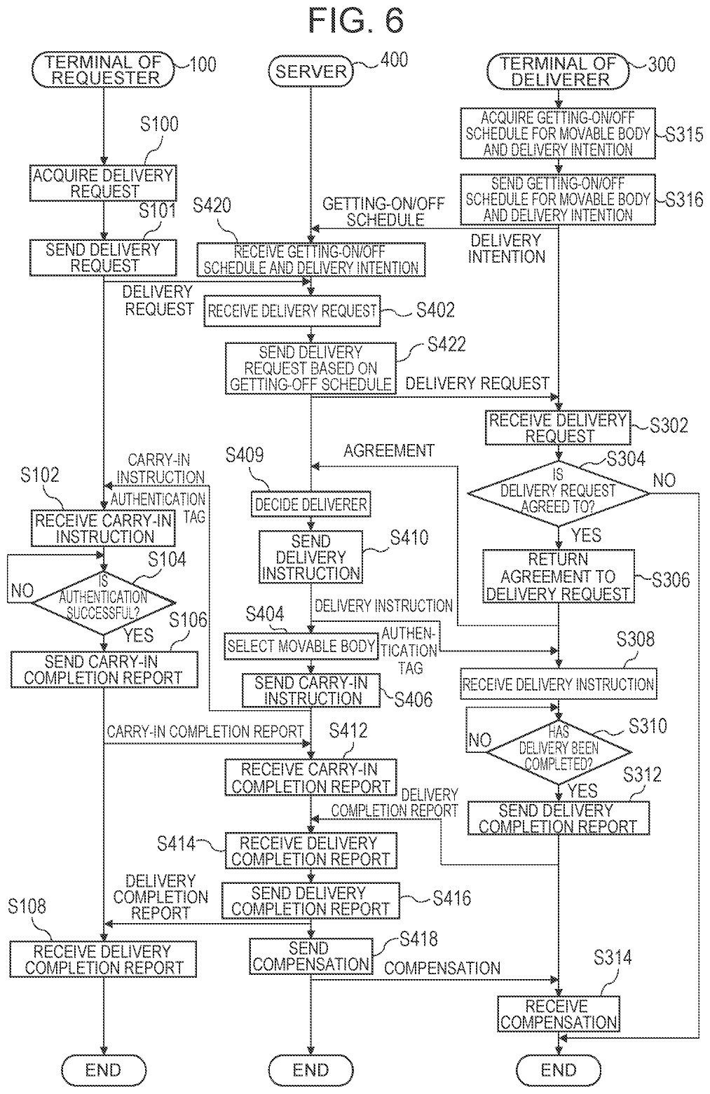

FIG. 6 is a sequence diagram showing processes that are performed by the terminal 100 of the requester, the terminal 300 of the deliverer, and the server 400, and is a diagram in the case of deciding the deliverer based on the getting-off schedule for the movable body 500. In this process, first, the deliverer is decided based on the getting-off schedule, and thereafter the movable body 500 is selected. Differences from FIG. 5 will be mainly described below.

First, the input information acquisition unit 310a of the control unit 310 of the terminal 300 acquires the getting-on/off schedule and the delivery intention that the deliverer has input by operating the input unit 350 (step S315). Next, the sending unit 310b of the control unit 310 sends the getting-on/off schedule and the delivery intention to the server 400 (step S316). The getting-on/off schedule and the delivery intention are received by the control unit 410 of the server 400 (step S420), and are stored in the storage unit 430. The user registration may be performed before step S315, similarly to step S300, step S301, and step S400 in FIG. 5.

When the server 400 receives the delivery request from the terminal 100 in step S402, the delivery request sending unit 410f of the control unit 410 sends the delivery request to the terminal 300 based on the getting-off schedule that is included in the getting-on/off schedule received from the terminal 300 (step S422). The delivery request is received by the receiving unit 310c of the control unit 310 of the terminal 300 (step S302). Processes that are performed by the control unit 310 of the terminal 300 after step S302 are the same as those in FIG. 5.

In the server 400, similarly to FIG. 5, the deliverer is decided in step S409, and the delivery instruction is sent to the terminal 300 in step S410. Thereafter, the movable body selection unit 410d of the control unit 410 selects the movable body 500 for which getting-off is scheduled to be performed, as the movable body in which the parcel is carried, based on the getting-off schedule for the terminal 300 having sent the delivery instruction, that is, based on the getting-off schedule for the terminal 300 of the decided deliverer (step S404), and the carry-in instruction sending unit 410e sends the carry-in instruction (step S406). Processes by the control unit 410 after step S412 are the same as those in FIG. 5. Further, processes that are performed by the control unit 110 of the terminal 100 of the receiver are the same as those in FIG. 5.

As described above, in the first embodiment, the delivery requester that requests the delivery of the parcel carries the parcel in the movable body 500 in accordance with the instruction from the server 400, and the deliverer unloads the parcel from the movable body 500 and delivers the parcel to the address of the receiver in accordance with the instruction from the server 400. Accordingly, it is possible to deliver the parcel using the movable body 500 that is usually operated. Further, the deliverer does not need to be a professional business operator, and therefore a dedicated vehicle and dedicated deliverer for delivering the parcel are unnecessary. Manpower shortage in the physical distribution service is eliminated, and delivery costs are reduced.

### 2. Second Embodiment

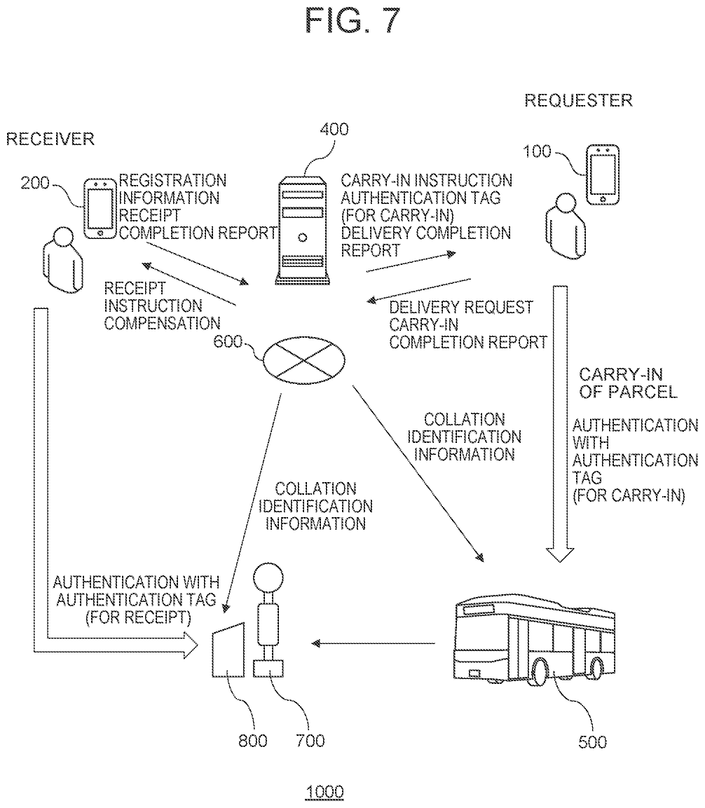

FIG. 7 is a schematic diagram showing the configuration of a parcel delivery system 1000 according to a second embodiment of the disclosure. The parcel delivery system 1000 is configured to include a terminal 100 of a delivery requester that requests the delivery of the parcel, a terminal 200 of a receiver of the parcel, a server 400, a plurality of movable bodies 500 that travels on roads and on which parcels are loaded, and a storage box 800 that is provided at a stop place 700 for the movable body 500.

In the second embodiment, the carry-in of the parcel in the movable body 500 by the requester is performed similarly to the first embodiment. In the second embodiment, the receiver goes to the stop place 700 where the parcel is unloaded, for receiving the parcel. Then, the receiver carries the parcel home from the stop place 700 by oneself Therefore, a receipt instruction is sent from the server 400 to the terminal 200 of the receiver. The receiver refers to the receipt instruction, and goes to the stop place 700 for receiving the parcel.

When the movable body 500 in which the parcel is carried arrives at the stop place 700, the parcel is put in the storage box 800. In the case where the storage box 800 is provided at the stop place 700, the receiver can receive the parcel put in the storage box 800 even when the receiver comes to the stop place 700 after the movable body 500 transports the parcel and departures from the stop place 700. Accordingly, the temporal flexibility when the receiver receives the parcel increases. The parcel is put in the storage box 800 by the crew that rides on the movable body 500. When the receipt of the parcel by the receiver is completed, the server 400 sends a compensation to the terminal 200 of the receiver.

As described above, in the parcel delivery system 1000 according to the embodiment, the requester that requests the delivery of the parcel carries the parcel in the movable body 500 in accordance with the instruction from the server 400. The parcel is transported by the movable body 500, and the receiver receives the parcel at the stop place 700 in accordance with the instruction from the server 400 and carries the parcel home. Accordingly, the terminal 300 of the deliverer described in the first embodiment is unnecessary. Further, similarly to the first embodiment, it is possible to deliver the parcel using the movable body 500 that is usually operated. Further, a dedicated vehicle and dedicated deliverer for delivering the parcel are unnecessary. Since an ordinary person participates in the physical distribution service, manpower shortage in the physical distribution service is eliminated, and delivery costs are reduced. Further, the receiver can obtain the compensation by conveying the parcel by oneself. Furthermore, the receiver can eliminate the lack of exercise and can achieve health promotion, by conveying the parcel home from the stop place 700.

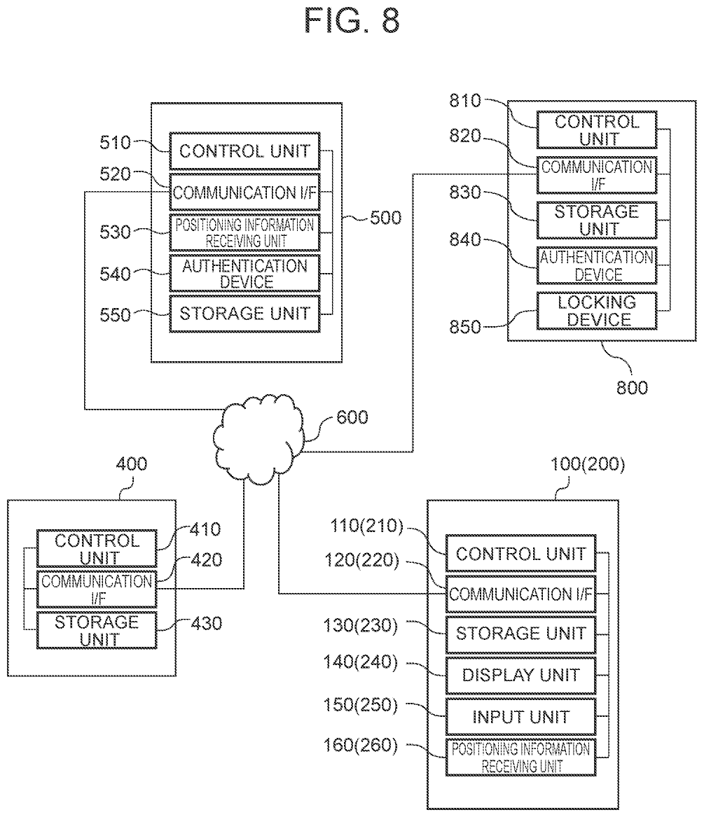

FIG. 8 is a block diagram showing hardware configurations of the terminals 100, 200, the server 400, the movable body 500, and the storage box 800. The configurations of the terminals 100, 200, the server 400, and the movable body 500 are the same as those in the first embodiment. The storage box 800 includes a control unit 810, a communication I/F 820, a storage unit 830, an authentication device 840, and a locking device 850.

The control unit 810 of the storage box 800 is constituted by a processor, similarly to the control unit 410 of the server 400. The communication I/F 820 of the storage box 800 includes a communication module that is connected with the communication network 600. For example, the communication I/F 820 may include a communication module that complies with a wired local area network (LAN) standard. The storage box 800 is connected with the communication network 600 through the communication I/F 820. The storage unit 830 of the storage box 800 includes a volatile semiconductor memory and a non-volatile semiconductor memory, and identification information received from the server 400 is stored. The authentication device 840 of the storage box 800 includes a reader (for example, a bar code reader or a QR (R) code reader) that reads an authentication tag for receipt, and collates the authentication tag for receipt, with collation identification information transmitted from the server 400 to the storage box 800. When a door of the storage box 800 is opened and the parcel is put in the storage box 800, the locking device 850 of the storage box 800 locks the door. Further, when the authentication by the authentication device 840 is successful, the locking device 850 unlocks the door. Thereby, the parcel is avoided from being taken out of the storage box 800 by a third person that has no authentication tag for receipt, so that credibility is secured.

In the second embodiment, the functional blocks of the control units 110, 210 respectively included in the terminal 100 of the delivery requester and the terminal 200 of the receiver are configured similarly to that in the first embodiment shown in FIG. 3.

The input information acquisition unit 110a of the control unit 110 of the terminal 100 of the delivery requester acquires the delivery request that the requester has input by operating the input unit 150. The sending unit 110b of the control unit 110 performs a process of sending the delivery request, the carry-in completion report, the position information about the terminal 100, and the like to the server 400 through the communication I/F 120. The receiving unit 110c of the control unit 110 performs a process of receiving the carry-in instruction that is an instruction for the movable body 500 in which the parcel is carried and that is sent from the server 400, through the communication I/F 120. Further, the receiving unit 110c performs a process of receiving the delivery completion report sent from the server 400, through the communication I/F 120.

The input information acquisition unit 210a of the control unit 210 of the terminal 200 of the receiver acquires the user registration information and delivery completion report that the receiver has input by operating the input unit 250. Further, the input information acquisition unit 210a acquires the degree of the lack of exercise that the receiver has input by operating the input unit 250. In the case where the terminal 200 includes a pedometer, the degree of the lack of exercise may be acquired based on the number of steps counted by the pedometer. The sending unit 210b of the control unit 210 performs a process of sending the user registration information, the position information about the terminal 200, the delivery completion report, the degree of the lack of exercise, and the like, to the server 400 through the communication I/F 220. The receiving unit 210c of the control unit 210 performs a process of receiving the receipt instruction for the parcel, the authentication tag for receipt, and the compensation, which are sent from the server 400, through the communication I/F 320. Further, the receiving unit 210c performs a process of receiving information that is relevant to the delivery status of the parcel and that is sent from the server 400, through the communication I/F 220.

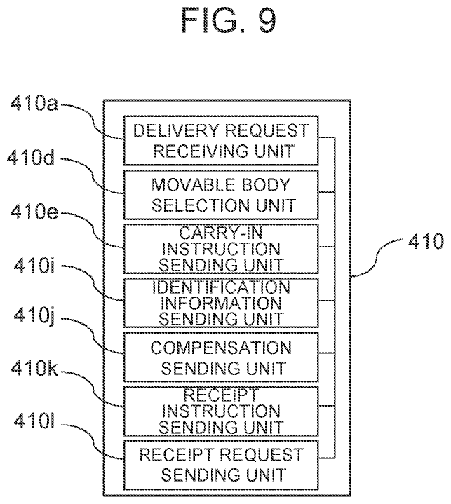

FIG. 9 is a schematic diagram showing a functional block of the control unit 410 that is included in the server 400, in the second embodiment. The control unit 410 of the server 400 includes a delivery request receiving unit 410a, a movable body selection unit 410d, a carry-in instruction sending unit 410e, an identification information sending unit 410i, a compensation sending unit 410j, a receipt instruction sending unit 410k, and a receipt request sending unit 4101. Unlike the first embodiment shown in FIG. 4, the control unit 410 does not include the delivery intention receiving unit 410b, the getting-off schedule receiving unit 410c, and the deliverer decision unit 410h, and includes the receipt instruction sending unit 410k and the receipt request sending unit 4101 instead of the delivery instruction sending unit 410g and the delivery request sending unit 410f shown in FIG. 4.

In FIG. 9, the delivery request receiving unit 410a, the movable body selection unit 410d, and the carry-in instruction sending unit 410e of the control unit 410 are configured similarly to the first embodiment. The compensation sending unit 410j sends the compensation for the receipt of the parcel to the terminal 200 to which the receipt instruction has been sent, in response to a receipt completion report for the parcel from the terminal 200.

The receipt instruction sending unit 410k of the control unit 410 sends the receipt instruction that is an instruction to receive the parcel at the stop place 700 for the movable body 500 where the parcel is unloaded, to the terminal 200 of the receiver. The receipt instruction includes the operation information about the movable body 500 in which the parcel is carried, the information designating the stop place 700 where the parcel is unloaded, and a scheduled time when the movable body 500 in which the parcel is carried stops at the stop place 700 where the parcel is unloaded. Further, the receipt instruction sending unit 410k sends an electronic authentication tag to be used for unlocking the door of the storage box 800, to the terminal 200 of the receiver.

Further, depending on the degree of the lack of exercise of the receiver, the receipt instruction sending unit 410k changes the stop place where the parcel is unloaded, to a stop place that is more distant from the address of the receiver, as the degree of the lack of exercise is higher. The degree of the lack of exercise of the receiver is received from the terminal 200 of the receiver.

Similarly to the first embodiment, the identification information sending unit 410i of the control unit 410 sends the collation identification information to be collated with the identification tag for carry-in that is sent to the terminal 100 by the carry-in instruction sending unit 410e, to the authentication device 540 that authenticates the authentication tag for carry-in that is included in the movable body 500 selected by the movable body selection unit 410d. Further, the identification information sending unit 410i sends, to the storage box 800, the collation identification information to be collated with the authentication tag for receipt that is sent to the terminal 200 by the receipt instruction sending unit 410k.

The receipt request sending unit 4101 of the control unit 410 sends, to the terminal 200 of the receiver, a request (receipt request) to receive the parcel at the stop place 700 where the parcel is unloaded. The receipt request includes the operation information about the movable body 500 in which the parcel is carried, the information designating the stop place 700 where the parcel is unloaded, the scheduled time when the movable body 500 in which the parcel is carried stops at the stop place 700 where the parcel is unloaded. The receipt instruction sending unit 410k sends the receipt instruction to the terminal 200 that has returned to the agreement to the receipt request.

The compensation sending unit 410j of the control unit 410 sends the compensation for the delivery to the terminal 200, in response to the receipt completion report for the parcel from the terminal 200 of the receiver to which the receipt instruction has been sent. The compensation sending unit 410j sends a higher compensation as the distance between the stop place where the parcel is unloaded and the address of the receiver is longer.

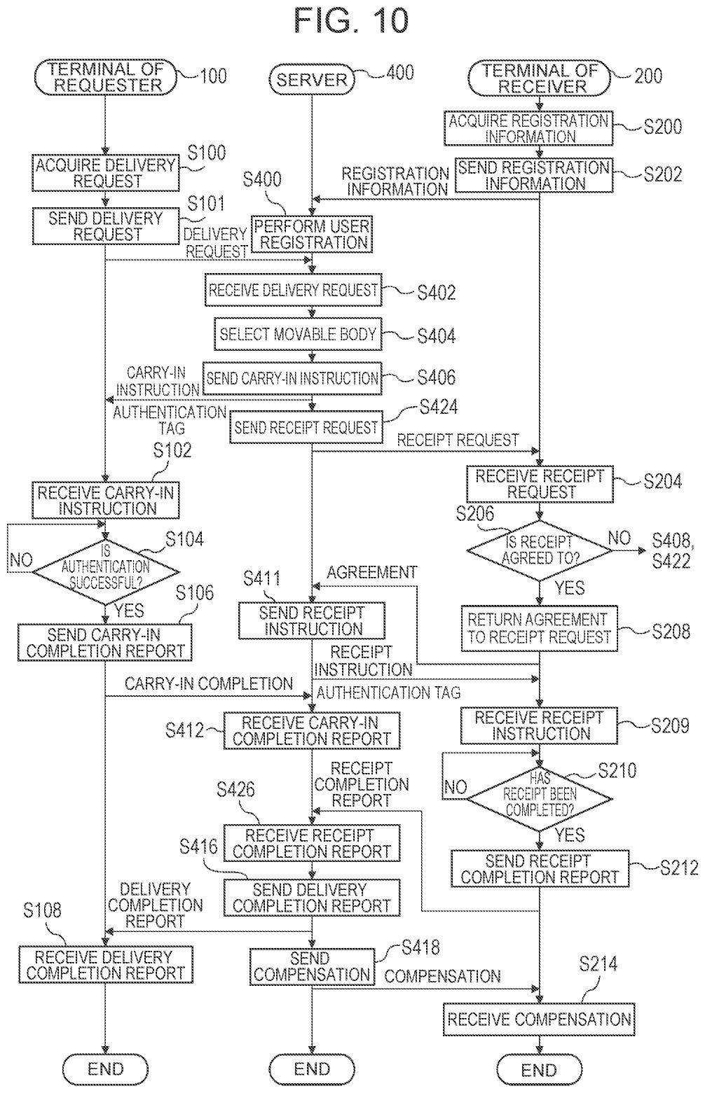

FIG. 10 is a sequence diagram showing processes that are performed by the terminal 100 of the delivery requester, the terminal 200 of the receiver, and the server 400. The processes shown in FIG. 10 are performed by the control unit 110 of the terminal 100 of the delivery requester, the control unit 210 of the terminal 200 of the receiver, and the control unit 410 of the server 400. In the sequence diagram shown in FIG. 10, the processes that are performed by the terminal 100 of the delivery requester are the same as processes described in FIG. 5 in the first embodiment, and some of the processes that are performed by the server 400 overlaps with processes in FIG. 5. Therefore, the processes that are performed by the control unit 210 of the terminal 200 of the receiver and processes that are different from processes in FIG. 5, of the processes by the control unit 410 of the server 400 will be mainly described.

First, the input information acquisition unit 210a of the control unit 210 of the terminal 200 of the receiver acquires the user registration information that the receiver has input by operating the input unit 250 (step S200). Next, the sending unit 210b of the control unit 210 sends the user registration information to the server 400 (step S202). The user registration information is registered in the storage unit 430 by the control unit 410 of the server 400 (step S400).

The server 400 sends the carry-in instruction in step S406, and thereafter the receipt request sending unit 4101 of the control unit 410 sends the receipt request to the terminal 200 of the receiver.

The receiving unit 210c of the control unit 210 of the terminal 200 receives the receipt request (step S204). The receipt request is displayed on the display unit 240 of the terminal 200, and it is determined whether the receipt is agreed to, based on the input to the input unit 250 (step S206). When it is determined that the receipt is agreed to, the sending unit 210b returns the agreement to the receipt request, to the server 400 (step S208). For example, when the owner of the terminal 200 operates an “agreement button” displayed on the display unit 240, it is determined that the receipt is agreed to, and the agreement to the receipt request is returned.

In the case where it is determined in step S206 that the receipt is not agreed to, that is, in the case where the owner of the terminal 200 does not agree to the receipt, the delivery request is sent to the terminal 300 in step S408 or step S422 in the first embodiment shown in FIG. 5 or FIG. 6.

When the server 400 receives the agreement to the receipt request, the receipt instruction sending unit 410k of the control unit 410 of the server 400 sends the receipt instruction to the terminal 200 of the receiver (step S411). The receipt instruction sending unit 410k sends the authentication tag for receipt to the terminal 200, together with the receipt instruction. Further, the identification information sending unit 410i of the control unit 410 of the server 400 sends the collation identification information to be collated with the authentication tag for receipt, to the storage box 800.

The owner (receiver) of the terminal 200 having received the receipt instruction takes the parcel out of the storage box 800 at the designated stop place 700, in accordance with the receipt instruction. When the receiver takes the parcel out of the storage box 800, the receiver performs the authentication by causing the authentication device 840 of the storage box 800 to read the authentication tag for receipt in a state where the authentication tag for receipt is displayed on the display unit 240 of the terminal 200. The authentication device 840 collates the authentication tag for receipt with the collation identification information received from the server 400. When the authentication by the authentication device 840 is successful, the locking device 850 unlocks the door of the storage box 800. Thereby, the receiver can take the parcel out of the storage box 800.

Thereafter, it is determined whether the receipt of the parcel has been completed (step S210). When it is determined that the receipt of the parcel has been completed, the sending unit 210b of the control unit 210 sends the receipt completion report to the server 400 (step S212). For example, when the owner of the terminal 200 operates a “receipt completion button” displayed on the display unit 240 after receiving the parcel, it is determined that the receipt has been completed, and the receipt completion report is sent.

When the server 400 receives the receipt completion report sent by the terminal 200 (step S426), the control unit 410 of the server 400 sends the delivery completion report to the terminal 100 of the requester (step S416).

The compensation sending unit 410j of the control unit 410 of the server 400 sends the compensation to the terminal 200 of the receiver that has completed the receipt of the parcel (step S418). The receiving unit 210c of the control unit 210 of the terminal 200 receives the compensation (step S214). The received compensation is stored in the storage unit 230 of the terminal 200. When buying products or enjoying various services at shops or the like, the owner of the terminal 200 can make a payment using the compensation stored in the storage unit 230.

In the second embodiment, it is allowable to adopt a configuration in which the storage box 800 is not provided at the stop place 700. In this case, the owner (receiver) of the terminal 200 having received the receipt instruction refers to the scheduled time included in the receipt instruction, that is, the scheduled time when the movable body 500 in which the parcel is carried stops at the stop place 700 where the parcel is unloaded, and goes to the stop place 700 at that time. Thereby, the owner (receiver) of the terminal 200 receives the parcel when the movable body 500 stops at the stop place 700. The receiver may get on the movable body 500 at a stop place before the stop place 700 where the receiver receives the parcel, and may unload the parcel from the movable body 500 when the movable body 500 stops at the stop place 700, based on the operation information about the movable body 500 in which the parcel is carried.

In this case, the collation identification information to be collated with the authentication tag for receipt is sent to the movable body 500 in which the parcel is carried. When the receiver receives the parcel, since the collation identification information to be collated with the authentication tag for receipt has been sent to the movable body 500, the receiver performs the authentication by causing the authentication device 540 to read the authentication tag for receipt in a state where the authentication tag for receipt is displayed on the display unit 240 of the terminal 200. When the authentication of the authentication tag for receipt is successful as a result of the authentication by the authentication device 540, the parcel is permitted to be unloaded. When the authentication is performed, the crew of the movable body 500 reads the authentication tag using the authentication device 540. Thereby, the parcel is avoided from being unloaded from the movable body 500 by a third person that has no authentication tag for receipt, so that credibility is secured.

As described above, in the second embodiment, the requester that requests the delivery of the parcel carries the parcel in the movable body 500 in accordance with the instruction from the server 400, and the receiver receives the parcel at the stop place in accordance with the receipt instruction from the server 400. Accordingly, it is possible to deliver the parcel using the movable body 500 that is usually operated. Further, a dedicated vehicle and dedicated deliverer for delivering the parcel are unnecessary. Therefore, manpower shortage in the physical distribution service is eliminated, and delivery costs are reduced.

What is claimed is:

1. A delivery management device comprising:
a delivery request receiving unit configured to receive a delivery request for a parcel from a first terminal, the first terminal being a terminal of a delivery requester that requests a delivery of the parcel;
a movable body selection unit configured to select a movable body that delivers the parcel, based on an address of a receiver of the parcel and operation information about a plurality of movable bodies that is periodically operated for each route, the address of the receiver being included in the delivery request; and
a carry-in instruction sending unit configured to send a carry-in instruction to the first terminal, the carry-in instruction being an instruction to carry the parcel in the selected movable body.

2. The delivery management device according to claim 1, wherein when the delivery request includes a designated delivery time, the movable body selection unit selects the movable body that delivers the parcel, based on the designated delivery time, the address of the receiver, and the operation information.

3. The delivery management device according to claim 1, further comprising:
a delivery intention receiving unit configured to receive a delivery intention from a second terminal, the delivery intention indicating an intention to deliver the parcel; and
a delivery instruction sending unit configured to send a delivery instruction to the second terminal, the delivery instruction being an instruction to unload the parcel at a stop place for the movable body and to deliver the parcel to the address of the receiver.

4. The delivery management device according to claim 3, wherein the delivery instruction includes the address of the receiver, operation information about the movable body in which the parcel is carried, and information designating the stop place where the parcel is unloaded.

5. The delivery management device according to claim 3, comprising a sending unit configured to send a request to deliver the parcel from the stop place to the address of the receiver, to a plurality of the second terminals,
wherein the delivery instruction sending unit sends the delivery instruction to the second terminal that has returned an agreement to the request earliest among the second terminals.

6. The delivery management device according to claim 3, comprising a getting-off schedule receiving unit configured to receive a getting-off schedule for the movable body, the getting-off schedule being sent by the second terminal, wherein:
the getting-off schedule includes a scheduled stop place for getting off the movable body; and
the delivery instruction sending unit sends the delivery instruction to the second terminal based on the address of the receiver and the getting-off schedule, the delivery instruction being an instruction to unload the parcel at the scheduled stop place for getting off the movable body, and to deliver the parcel to the address of the receiver.

7. The delivery management device according to claim 6, comprising a sending unit configured to send a request to deliver the parcel from the scheduled stop place for getting off the movable body to the address of the receiver, to the second terminal that has sent the getting-off schedule for getting off the movable body at a stop place close to the address of the receiver,
wherein the delivery instruction sending unit sends the delivery instruction to the second terminal for which the scheduled stop place for getting off the movable body is closest to the address of the receiver among the second terminals that have returned an agreement to the request.

8. The delivery management device according to claim 7, wherein:
the getting-off schedule includes a scheduled time for getting off the movable body; and
when the delivery request includes a designated delivery time, the sending unit sends the request to the second terminal that has sent the getting-off schedule in which the scheduled time is close to the designated delivery time.

9. The delivery management device according to claim 6, wherein based on the getting-off schedule for the second terminal to which the delivery instruction has been sent, the movable body selection unit selects the movable body for which getting-off is scheduled to be performed, as the movable body in which the parcel is carried.

10. The delivery management device according to claim 3, wherein depending on degree of lack of exercise of an owner of the second terminal, the delivery instruction sending unit changes the stop place where the parcel is unloaded, to a stop place that is more distant from the address of the receiver, as the degree of the lack of exercise is higher, the degree of the lack of exercise being received from the second terminal.

11. The delivery management device according to claim 3, wherein:
the delivery instruction sending unit sends first identification information for authentication to the second terminal, the first identification information being used when the parcel is unloaded from the movable body at the stop place; and
the delivery management device comprises an identification information sending unit configured to send collation identification information to an authentication device, the collation identification information being collated with the first identification information, the authentication device being included in the selected movable body and authenticating the first identification information.

12. The delivery management device according to claim 3, further comprising a compensation sending unit configured to send a compensation for the delivery to the second terminal to which the delivery instruction has been sent, in response to a delivery completion report for the parcel from the second terminal.

13. The delivery management device according to claim 1, comprising a receipt instruction sending unit configured to send a receipt instruction to a third terminal, the receipt instruction being an instruction to receive the parcel at a stop place for the movable body where the parcel is unloaded, the third terminal being a terminal of the receiver.

14. The delivery management device according to claim 13, comprising a receipt request sending unit configured to send a receipt request to the third terminal, the receipt request being a request to receive the parcel at the stop place where the parcel is unloaded,
wherein the receipt instruction sending unit sends the receipt instruction to the third terminal that has returned an agreement to the receipt request.

15. The delivery management device according to claim 13, wherein the receipt instruction includes operation information about the movable body in which the parcel is carried and information designating the stop place where the parcel is unloaded.

16. The delivery management device according to claim 13, wherein:
the parcel unloaded from the movable body is stored in a storage box that is provided at the stop place for the movable body;
the receipt instruction sending unit sends second identification information for authentication to the third terminal, the second identification information being used for unlocking a door of the storage box; and
the delivery management device comprises an identification information sending unit configured to send collation identification information to an authentication device, the collation identification information being collated with the second identification information, the authentication device being included in the storage box and authenticating the second identification information.

17. The delivery management device according to claim 15, wherein the receipt instruction further includes a scheduled time when the movable body stops at the stop place where the parcel is unloaded.

18. The delivery management device according to claim 13, wherein depending on degree of lack of exercise of the receiver, the receipt instruction sending unit changes the stop place where the parcel is unloaded, to a stop place that is more distant from the address of the receiver, as the degree of the lack of exercise is higher, the degree of the lack of exercise being received from the third terminal.

19. The delivery management device according to claim 13, further comprising a compensation sending unit configured to send a compensation for the receipt of the parcel to the third terminal to which the receipt instruction has been sent, in response to a receipt completion report for the parcel from the third terminal.

20. The delivery management device according to claim 12, wherein the compensation sending unit sends a higher compensation as a distance between the stop place where the parcel is unloaded and the address of the receiver is longer.

21. The delivery management device according to claim 3, wherein the stop place where the parcel is unloaded is a stop place nearest to the address of the receiver.

22. The delivery management device according to claim 1, wherein:
the carry-in instruction sending unit sends third identification information for authentication to the first terminal, the third identification information being used when the parcel is carried in the movable body; and
the delivery management device comprises an identification information sending unit configured to send collation identification information to an authentication device, the collation identification information being collated with the third identification information, the authentication device being included in the selected movable body and authenticating the third identification information.

23. A delivery management method comprising:
a step of receiving a delivery request for a parcel from a terminal of a delivery requester that requests a delivery of the parcel;
a step of selecting a movable body that delivers the parcel, based on an address of a receiver of the parcel and operation information about a plurality of movable bodies that is periodically operated for each route, the address of the receiver being included in the delivery request; and
a step of sending a carry-in instruction to the terminal, the carry-in instruction being an instruction to carry the parcel in the selected movable body.
